(19) United States
(12) Patent Application Publication
(10) Pub. No.: US 2024/0320895 A1
(43) Pub. Date: Sep. 26, 2024

(54) STREAK VISUAL EFFECT GENERATING METHOD, VIDEO GENERATING METHOD, AND ELECTRONIC DEVICE

(71) Applicant: Beijing Zitiao Network Technology Co., Ltd., Beijing (CN)

(72) Inventors: Yi GUO, Beijing (CN); Xiaole XUE, Beijing (CN); Jiali PAN, Beijing (CN)

(21) Appl. No.: 18/269,866

(22) PCT Filed: Nov. 24, 2021
(86) PCT No.: PCT/CN2021/132638

§ 371 Date: Jun. 27, 2023

(30) Foreign Application Priority Data
Dec. 28, 2020 (CN) 202011584142.9

(51) Int. Cl. G06T 15/00; G06T 7/246; G06V 10/44; H04N 5/265

(52) U.S. Cl. CPC G06T 15/00; G06T 7/246; G06V 10/44; H04N 5/265; G06T 2207/30241; G06V 2201/07

(57) ABSTRACT

A method for generating a trailing visual effect based on a particle flow, a method for generating a video, an electronic device, and a non-transitory computer-readable storage medium are provided. The method for generating the trailing visual effect based on the particle flow includes: acquiring an extending trajectory of the particle flow; generating, in a three-dimension space for generating the trailing visual effect, a plurality of particles for forming the particle flow according to the extending trajectory; rendering the plurality of particles to obtain a plurality of particle primitive models; and generating the trailing visual effect based on the plurality of particle primitive models. The method for generating the trailing visual effect based on the particle flow can generate particles along the extending trajectory of the particle flow to form the trailing visual effect.

### CROSS-REFERENCE TO RELATED APPLICATION

The present application claims priority of Chinese Patent Application No. 202011584142.9, filed on Dec. 28, 2020, and the entire content disclosed by the Chinese patent application is incorporated herein by reference as part of the present application.

### TECHNICAL FIELD

The embodiments of the present disclosure relate to a method for generating a trailing visual effect based on a particle flow, a method for generating a video, an electronic device, and a non-transitory computer-readable storage medium.

### BACKGROUND

A particle system may be adopted to implement digital trailing visual effects. The three-dimension computer graphics technology may be used for rendering a virtual three-dimension space in the computer, and three-dimension objects in the three-dimension space are depicted using discrete mathematical expressions (e.g., triangular surfaces). These discrete three-dimension objects are referred to as three-dimension (3D) models. In the three-dimension space, colors, textures, light and shadow effects, and the like ultimately presented by these three-dimension models are defined and depicted through a series of graphic algorithms and rules. These algorithms and encapsulations that define colors in which the three-dimension objects are visually presented are commonly referred to as three-dimension model materials.

In three-dimension computer graphics, the particle system may be used for simulating visual special effects such as fire, explosion, smoke, water flow, sparks, fallen leaves, clouds, fog, snow, dust, wake of a meteor, luminous trajectories, etc. However, in the existing technologies, there is no method based on the particle system to obtain a trailing visual effect having a realistic visual effect.

### SUMMARY

The part of the summary is provided so as to introduce the ideas in a brief form, these ideas will be described in detail in the later specific embodiments. The part of the summary is not intended to identify the key features or necessary features of the technical solution required to be protected, nor is it intended to limit the scope of the technical solution required to be protected.

At least one embodiment of the present disclosure provides a method for generating a trailing visual effect based on a particle flow, which comprises: acquiring an extending trajectory of the particle flow: generating, in a three-dimension space for generating the trailing visual effect, a plurality of particles for forming the particle flow according to the extending trajectory: rendering the plurality of particles to obtain a plurality of particle primitive models; and generating the trailing visual effect based on the plurality of particle primitive models.

At least one embodiment of the present disclosure provides a method for generating a video, which comprises: determining a visual effect trajectory in a video to be processed: generating a trailing visual effect at the visual effect trajectory, where the trailing visual effect is generated according to the method for generating the trailing visual effect according to any one embodiment of the present disclosure; and superimposing the trailing visual effect in the video to be processed to generate the video.

At least one embodiment of the present disclosure provides an electronic device, which comprises: a memory, for non-transitorily storing computer-readable instructions: a processor, configured to execute the computer-executable instructions, where the computer-executable instructions, when executed by the processor, implement the method for generating the trailing visual effect according to any one embodiment of the present disclosure.

At least one embodiment of the present disclosure provides a non-transitory computer-readable storage medium, the non-transitory computer-readable storage medium stores computer-executable instructions, and the computer-executable instructions, when executed by a processor, implement the method for generating the trailing visual effect according to any one embodiment of the present disclosure.

### BRIEF DESCRIPTION OF THE DRAWINGS

In order to more clearly illustrate the technical solutions of the embodiments of the present disclosure, the drawings of the embodiments will be briefly described in the following: it is obvious that the described drawings below are only related to some embodiments of the present disclosure and thus are not limitative to the present disclosure.

FIG. 1A is a schematic flowchart of a method for generating a trailing visual effect provided by at least one embodiment of the present disclosure:

FIG. 1B is a schematic diagram of a plurality of particle maps provided by at least one embodiment of the present disclosure:

FIG. 2A is a schematic diagram of a change curve of an attribute value of particle transparency provided by an embodiment of the present disclosure:

FIG. 2B is a schematic diagram of a change curve of an attribute value of particle transparency provided by an embodiment of the present disclosure:

FIG. 2C is a schematic diagram of a change curve of a second factor provided by an embodiment of the present disclosure:

FIG. 2D is a schematic diagram of a change curve of an attribute value of particle transparency provided by an embodiment of the present disclosure:

FIG. 2E is a schematic diagram of a change curve of another second factor provided by an embodiment of the present disclosure:

FIG. 3A is a schematic flowchart of a method for generating a video provided by at least one embodiment of the present disclosure:

FIG. 3B is a schematic diagram of a trailing visual effect provided by at least one embodiment of the present disclosure:

FIG. 3C is a schematic diagram of a trailing visual effect provided by at least one embodiment of the present disclosure:

FIG. 4 is a schematic block diagram of an electronic device provided by at least one embodiment of the present disclosure:

FIG. 5 is a schematic diagram of a non-transitory computer-readable storage medium provided by at least one embodiment of the present disclosure; and

FIG. 6 is a structural schematic diagram of another electronic device provided by at least one embodiment of the present disclosure.

### DETAILED DESCRIPTION

Embodiments of the present disclosure will be described in greater detail below with reference to the accompanying drawings. While some embodiments of the present disclosure are shown in the accompanying drawings, it should be understood, however, that the present disclosure may be implemented in various forms and should not be construed as being limited to the embodiments set forth herein: on the contrary, these embodiments are provided for a more thorough and complete understanding of the present disclosure. It should be understood that the accompanying drawings and embodiments of the present disclosure are for exemplary purposes only and are not intended to limit the scope of protection of the present disclosure.

It should be understood that all the steps recorded in the implementations of the method provided by the present disclosure can be performed in different orders, and/or performed in parallel. Further, the implementations of the method can include additional steps and/or omit performing the steps illustrated. The scope of the present disclosure is not limited in this respect.

The term “comprise/include” and variations thereof as used herein mean openly comprising/including, i.e. “comprising/including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first”, “second”, etc. mentioned in the present disclosure are only used for distinguishing different devices, modules, or units, and are not intended to limit the order or interdependence of the functions performed by these devices, modules, or units.

It should be noted that the modifications of “one” and “plurality” mentioned in the present disclosure are schematic rather than restrictive, and those skilled in the art should understand that unless otherwise expressly indicated in the context, it should be understood as “one or more”.

The names of messages or information interacted between a plurality of devices in the embodiments of the present disclosure are used for illustrative purposes only and are not used to limit the scope of such messages or information.

In graphics, a particle effect refers to a special type of rendering capability encapsulation. Generating a group of point sets, that is, a plurality of particles, in a three-dimension space, then replacing each particle in the point sets with a 3D model (most commonly a flat model), and then rendering with a specific material, so that a visual effect of the particle may be generated. The particle effect is usually used to create a visual specific effect such as cloud, flame, etc.

CPU (Central Processing Unit) particles and GPU (Graphics Processing Unit) particles are two technical means to implement the particle effect.

Each individual particle in a particle effect has a complete particle lifecycle, including an initialization stage, an update stage, and a rendering stage: after the rendering stage ends, a particle primitive model corresponding to the particle may be generated.

At least one embodiment of the present disclosure provides a method for generating a trailing visual effect based on a particle flow; an electronic device, and a non-transitory computer-readable storage medium. The method for generating the trailing visual effect based on the particle flow comprises the following steps: acquiring an extending trajectory of the particle flow: generating, in a three-dimension space for generating the trailing visual effect, a plurality of particles for forming the particle flow according to the extending trajectory: rendering the plurality of particles to obtain a plurality of particle primitive models; and generating the trailing visual effect based on the plurality of particle primitive models. The method for generating the trailing visual effect based on the particle flow can generate particles along the extending trajectory of the particle flow to form the trailing visual effect.

It should be noted that the method for generating the trailing visual effect provided by the embodiment of the present disclosure may be applied at least partially to appropriate electronic devices: for example, in some embodiments, the method for generating the trailing visual effect may be implemented locally through applications installed in electronic devices or non-installed applications downloaded from, for example, cloud servers. The electronic devices may include personal computers, mobile terminals, etc.: these mobile terminals may be devices such as a mobile phone, a tablet, a wearable electronic device, a smart home device, etc. For example, in some embodiments, the method for generating the trailing visual effect may also be implemented through a server, or some steps in the method for generating the trailing visual effect may be implemented through a server (e.g., a cloud server), while other steps may be implemented locally through the electronic devices, and the electronic devices, for example, communicate with each other through a network (e.g., a wireless or wired communication network).

In the embodiment of the present disclosure, the trailing visual effect may include a visual effect displayed on a display interface of an electronic device.

Embodiments of the present disclosure will be described in detail with reference to the accompanying drawings, but the present disclosure is not limited to these specific embodiments.

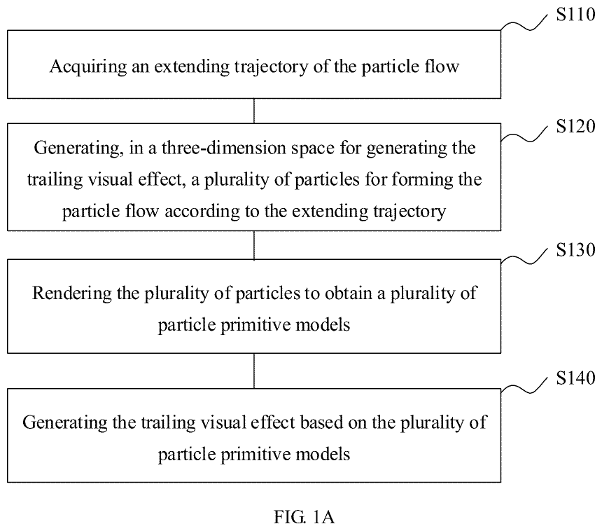

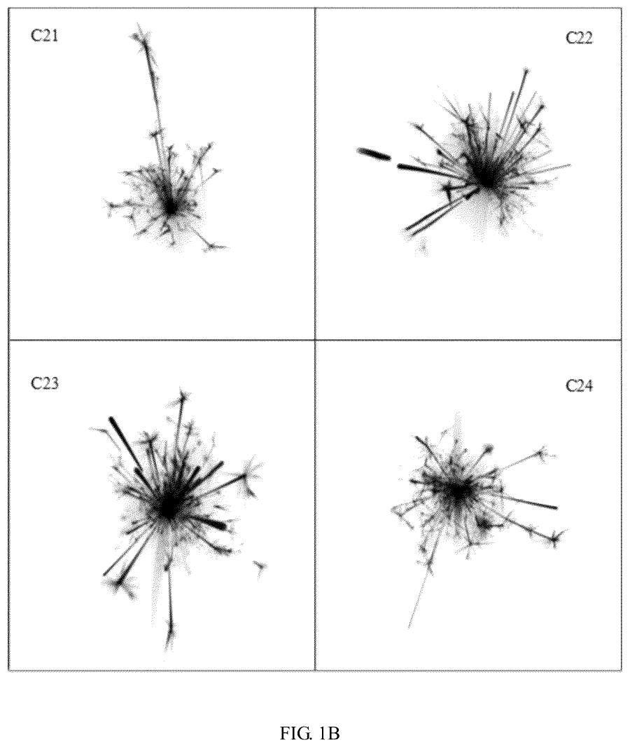

FIG. 1A is a schematic flowchart of a method for generating a trailing visual effect based on a particle flow provided by at least one embodiment of the present disclosure.

For example, as shown in FIG. 1A, the method for generating the trailing visual effect based on the particle flow includes steps S110 to S140.

In step S110, acquiring an extending trajectory of the particle flow.

In step S120, generating, in a three-dimension space for generating the trailing visual effect, a plurality of particles for forming the particle flow according to the extending trajectory.

In step S130, rendering the plurality of particles to obtain a plurality of particle primitive models.

In step S140, generating the trailing visual effect based on the plurality of particle primitive models.

The method for generating the trailing visual effect based on the particle flow can achieve the trailing visual effect through a plurality of particle primitive models, and the trailing visual effect has rich and realistic three-dimension visual effects, thus improving the visual experience of the user. In some embodiments, the method for generating the trailing visual effect based on the particle flow can simulate the real trailing effect. In other embodiments, it is also possible to combine technologies such as AR (Augmented Reality) and target object tracking detection to achieve that a trailing visual effect is generated as the target object moves, and the trailing visual effect is displayed and superimposed with the target object in the video through, for example, augmented reality technology.

A plurality of particles are generated and rendered based on GPU particle technology. Because GPU particle technology can support more particles than CPU, GPU particle technology is more suitable for generating the effect that uses a large number of particles, and the trailing visual effect consists of particle primitive models corresponding to particles generated continuously along the extending trajectory, so GPU particle technology is more suitable for generating the trailing visual effect.

For example, the trailing visual effect may be a three-dimension dynamic visual effect. When the trailing visual effect is used to form a video clip, the trailing visual effects displayed in various video frames of the video clip may be different from each other.

In some embodiments, the extending trajectory of the particle flow may be determined according to the movement of the target object. For example, step S110 may include: acquiring a video to be processed: detecting a target object in the video to be processed; determining a movement trajectory of the target object in the video to be processed; and converting the movement trajectory into the extending trajectory of the particle flow, for example, the extending trajectory is a trajectory that is obtained by mapping the movement trajectory into the three-dimension space.

For example, the three-dimension space may represent a virtual three-dimension space where the plurality of particles are located, and the virtual three-dimension space may be determined by a virtual three-dimension coordinate system. It should be noted that a two-dimensional plane may be a special case of a three-dimension space, that is, if a certain dimension of the three-dimension space is 0, the three-dimension space represents a two-dimensional plane, and correspondingly, the trailing visual effect based on the particle flow obtained by the method of at least one embodiment of the present disclosure is obtained by rendering in the two-dimensional plane.

Step S120 may include: generating the plurality of particles at equal intervals or random intervals along the extending trajectory: or generating the plurality of particles at equal time intervals or random time intervals along the extending trajectory.

Generating the plurality of particles at equal intervals along the extending trajectory may include: every time the target object moves a predetermined distance along the extending trajectory, randomly generating at least one particle in a three-dimension region including a position where the target object is located to form the particle flow:

The three-dimension region may be a sphere, a cube, a cuboid, an ellipsoid, etc. For example, the position of the target object may be any position in the three-dimension region, for example, the position of the target object is the center of the sphere.

N particles are generated every time the target object moves by a unit distance, here the unit distance is the unit distance in the above-mentioned virtual three-dimension space, for example, the unit distance is 1 “meter” or other set virtual unit distance (for example, it is selected as one percent of the width or length of the virtual three-dimension space) in the virtual three-dimension space, according to the scale adopted in the virtual three-dimension space, in this case, the predetermined distance may be the ratio of the unit distance to N, that is, (1/N) meter, where N is a positive integer greater than or equal to 1. That is to say, with the continuous movement of the target object, new particles are continuously generated on the movement trajectory of the target object.

In other embodiments, the extending trajectory is a preset trajectory. For example, the extending trajectory is a preset heart-shaped trajectory, a five-pointed star trajectory, a character trajectory, etc. The trailing visual effect generated along the preset extending trajectory may be superimposed with the video to be processed to generate a video clip or dynamic picture with the trailing visual effect.

Generating the plurality of particles at equal intervals along the extending trajectory may include: along the extending trajectory, sequentially randomly generating at least one particle in each of three-dimension regions respectively including positions at every predetermined distance on the extending trajectory to form the particle flow:

For example, each particle in the plurality of particles has at least one visual attribute, and the at least one visual attribute at least comprises one or more selected from a group consisting of particle size, particle color, particle transparency, and particle rotation speed, and the at least one visual attribute is used for controlling a visual effect of a particle primitive model corresponding to the particle. That is to say, visual attributes may be set for particles to achieve various visual effects, such as visual changes, in the trailing visual effect according to display needs.

It should be noted that, according to the needs of visual effects, other attributes of the particles may also be selected as visual attributes to achieve the required visual effects, such as particle orientation, particle position, etc., which is not limited in the present disclosure.

Each particle also has a lifecycle attribute, the lifecycle attribute is used to define the lifecycle of the particle primitive model corresponding to the particle.

For example, in the lifecycle of a particle, the attribute value of the visual attribute of the particle may be updated, and the particle primitive model corresponding to the particle may be controlled to generate corresponding visual changes based on the updated attribute value of the visual attribute of the particle, so as to simulate the visual effect corresponding to the particle primitive model to change with time.

Step S130 may include: updating attribute values of a plurality of particle attributes based on a rendering frame rate to obtain updated attribute values of the plurality of particle attributes corresponding to a plurality of particles one by one: obtaining particle maps corresponding to the plurality of particles: rendering the plurality of particles based on the particle maps and the updated attribute values of the plurality of particle attributes corresponding to the plurality of particles one by one, to obtain a plurality of particle primitive models.

FIG. 1B shows an example of a plurality of particle maps. As shown in FIG. 1B, the particle maps may include particle maps C21-C24, and embodiments of the present disclosure do not limit the specific shapes of the particle maps.

For each particle, in the initialization stage, the electronic device may randomly select a particle map from the particle maps to render the particle and display, and then, in the lifecycle of the particle, may also randomly or sequentially switch the particle map used for rendering according to a certain switching frequency (such as a set frequency or a time-varying frequency, etc.). Alternatively, when rendering each particle, randomly selecting a particle map from the particle maps C21-C24 to render the particle to obtain the corresponding visual effect.

The particle primitive model is a patch model generated based on the updated attribute values of the visual attributes (for example, at least some particle attributes used to achieve the visual effect), and is obtained by rendering the patch model based on particle maps. For example, the particle map may be arbitrarily selected according to the needs of visual effects. In addition, during each rendering, a fixed particle map may be selected for rendering, or different particle maps may be selected for rendering, and the present disclosure does not limit this.

In one embodiment, step S140 may include: superimposing the plurality of particle primitive models to generate the trailing visual effect corresponding to the particle flow:

In order to form the trailing visual effect, at least some of the plurality of particle primitive models display for at least a preset time period, that is, among the plurality of particle primitive models corresponding to the plurality of particles generated in sequence along the extending trajectory, at least some particle primitive models used for visually forming the trailing visual effect need to be displayed for at least a certain period of time before disappearing, thus visually forming the trailing visual effect. The preset time period may be determined according to the display needs of the trailing visual effect. For example, in some embodiments, the preset time period is 3 seconds, and in other embodiments, the preset time period may be 10 seconds. In order to obtain a better trailing visual effect, the preset time period may be set to an appropriate length, for example, the preset time period may be any length of time greater than 3 seconds.

It should be noted that the preset time period in the present disclosure defines the lower limit of the time that the particle primitive model needs to be displayed. According to the display needs, some particle primitive models need to display for at least the first preset time period, and some particle primitive models need to display for at least the second preset time period. The first preset time period and the second preset time period are different. At this time, the preset time period may be the minimum of the first preset time period and the second preset time period.

The visual disappearance of the particle primitive model may be implemented in two ways. For example, one way is to set the lifecycle of the particle to be greater than or equal to the preset time period, so that the particle primitive model corresponding to the particle disappears after displaying the time period set by the lifecycle attribute, thus achieving the visual disappearance effect of the particle primitive model. For example, the lifecycles of at least some particle primitive models are greater than or equal to the preset time period. For example, the lifecycle of the particle primitive model may be a random value within a certain range or a fixed value, for example, the preset time period is 5 seconds, and the lifecycle of the particle primitive model may be any value greater than 5 seconds, for example, 6 seconds.

Another way is to set the transparency of the particle primitive model to be completely transparent after displaying the preset time period, so that the particle is invisible after the preset time period, resulting in the effect of “disappearing” visually. For example, the lifecycle of the particle may be infinitely long or much longer than the preset time period. After displaying at least some particle primitive models for the preset time period, the transparencies of the at least some particle primitive models may be adjusted to be completely transparent successively according to the order of generating the particles. For example, in chronological order, the earlier the particles generated, the earlier the particles are adjusted, for example, particles A, B, C and so on are generated in sequence along the extending trajectory. Firstly, the transparency of the particle primitive model corresponding to the particle A is adjusted to be completely transparent, then the transparency of the particle primitive model corresponding to the particle B is adjusted to be completely transparent, and then the transparency of the particle primitive model corresponding to the particle C is adjusted to be completely transparent, and so on, and the adjustment time interval between two adjacent particles may be equal, for example, adjusting the transparency of a plurality of particle primitive models at first time intervals in sequence.

For example, the visual effect may include transparency change, color change, size change, rotation change, etc. The trailing visual effect may be obtained by superimposing particle primitive models with rich visual effects, a rich and realistic trailing visual effect is obtained, thus enhancing the visual experience of users.

For example, the visual effect includes the transparency change of the particle primitive model, for example, the transparency change is controlled by the attribute value of the particle transparency of the particle corresponding to the particle primitive model.

For example, in some embodiments, the transparency change comprises changing a transparency of the particle primitive model from a first transparency to a second transparency and then to a third transparency during the lifecycle of the particle primitive model, for example, both the first transparency and the third transparency are different from the second transparency.

For example, the first transparency and the third transparency may be the same or different. For example, in some embodiments, both the first transparency and the third transparency may be completely transparent, and the second transparency may be completely opaque, in this case, both the first transparency and the third transparency are lower than the second transparency, and the particle primitive model presents a visual effect of fading in and out.

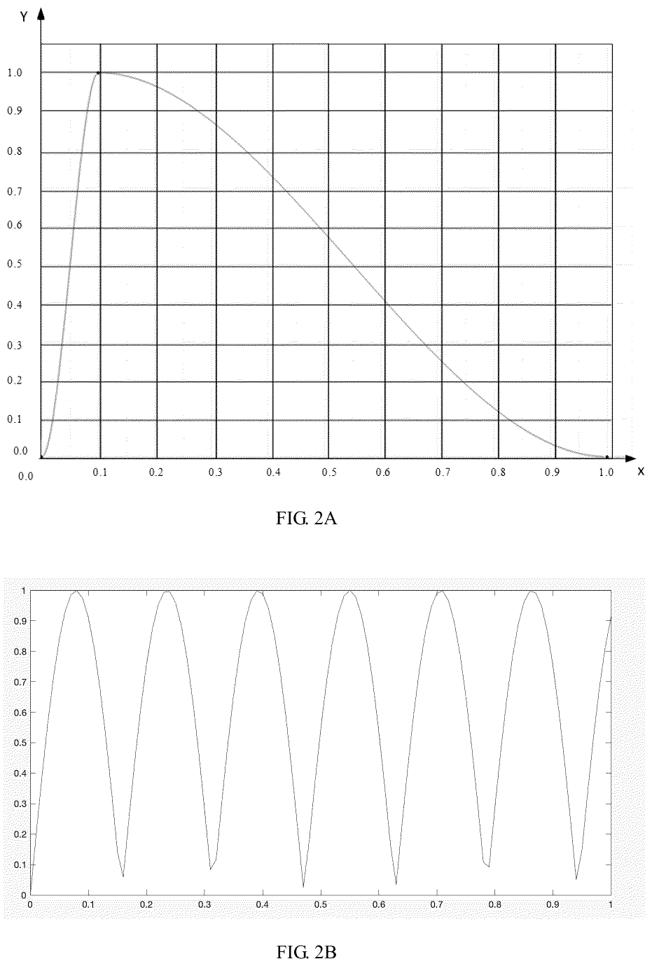

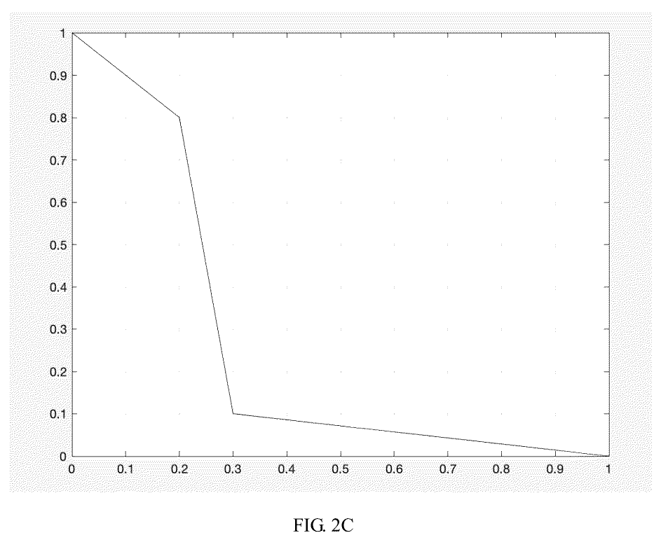

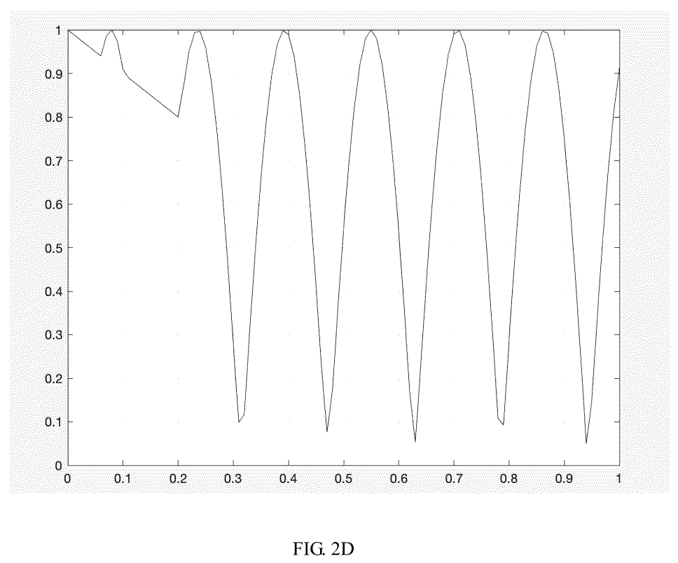

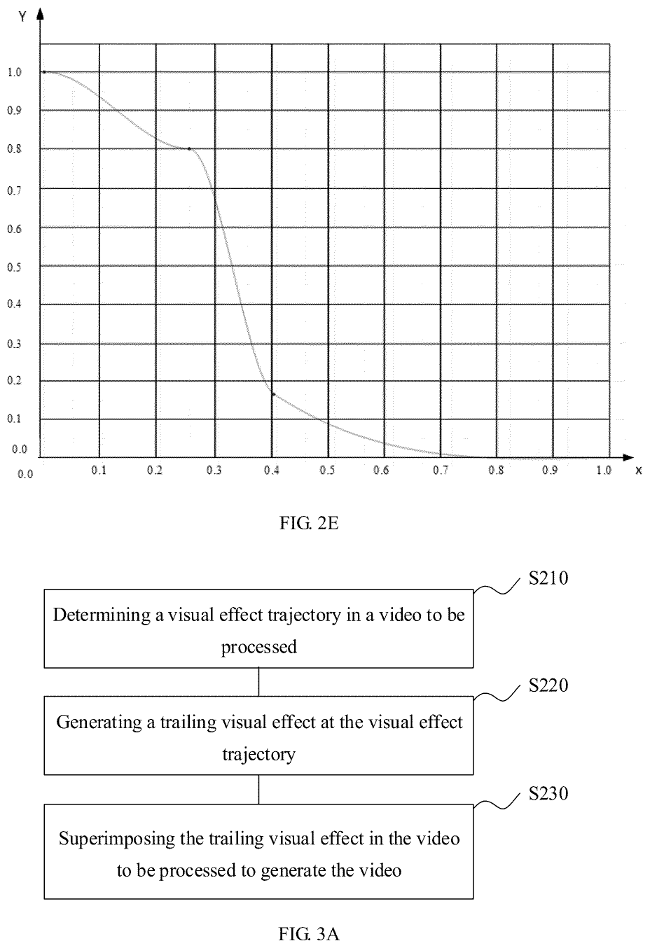

FIG. 2A is a schematic diagram of a change curve of an attribute value of particle transparency provided by an embodiment of the present disclosure. As shown in FIG. 2A, the coordinate value of the abscissa indicates the ratio of the existing time period of a particle to a lifecycle of the particle, for example, the lifecycle of the particle is 10 seconds, and the abscissa value “1” in FIG. 2A indicates that the particle has existed for 10 seconds and is about to die, and the abscissa value “0.1” indicates that the particle has existed for 1 second; the coordinate value of the ordinate indicates the attribute value of the particle transparency of the particle, the coordinate value “1” of the ordinate indicates that the particle is completely opaque, and the coordinate value “0” of the ordinate indicates that the particle is completely transparent, that is, in an invisible state. It should be noted that here, the attribute value of the particle transparency is represented by a numerical value between 0 and 1, and in other embodiments, other forms of representation may also be adopted, which is not limited by the present disclosure.

As shown in FIG. 2A, for example, the lifecycle of a particle is t seconds, and the attribute value of the particle transparency of the particle reaches 1 in the a-th second after birth, for example, a=0.1*t, at this time, the particle primitive model corresponding to the particle is completely opaque: after that, the attribute value of the particle transparency gradually decreases, and at the end of the lifecycle, that is, at the t-th second after birth, the attribute value of the particle transparency decreases to 0, and at this time, the particle primitive model corresponding to the particle is completely transparent. Through the change curve of the attribute value of the particle transparency as shown in FIG. 2A, in the lifecycle of the particle primitive model, the transparency of the particle primitive model may be controlled to quickly become opaque at first, then the transparency gradually decreases, and finally the transparency becomes completely transparent, that is, it presents a visual effect of fading in and out.

For example, in other embodiments, both the first transparency and the third transparency may be completely opaque, and the second transparency may be completely transparent. At this time, both the first transparency and the third transparency are higher than the second transparency, and the particle primitive model presents a visual effect of fading out and in.

It should be noted that in the present disclosure, the lower the transparency, the closer the transparency of the particle primitive model is to complete transparency, that is, the closer the attribute value of the particle transparency corresponding to the particle primitive model is to 0; on the contrary, the higher the transparency, the closer the transparency of the particle primitive model is to complete opaque, that is, the closer the attribute value of the particle transparency corresponding to the particle primitive model is to 1.

In other embodiments, the transparency change includes periodically changing a transparency of the particle primitive model within the lifecycle of the particle primitive model. For example, when the transparency of the particle primitive model changes periodically, it presents a flicker effect visually.

For example, the particle transparency of the i-th particle among the plurality of particles is expressed as formula (1):

$${B}_{i} ( t ) = abs ( sin ( rb ( i ) + t * v ) ) \qquad formula ( 1 )$$

where Bᵢ (t) represents the particle transparency of the i-th particle at time t, t represents the time period when the i-th particle has existed, sin(*) represents a sine function, abs(*) represents seeking the absolute value, rb(i) represents the random value of the flickering rhythm corresponding to the i-th particle, and v represents the flickering frequency.

In this case, the change of the transparency of the particle primitive model corresponding to the i-th particle may be controlled by Bᵢ (t), so that the periodic change of the transparency is visually presented, resulting in a flickering effect.

For example, the higher the flickering frequency, the more times the particle primitive model flickers per unit time. The random value of flickering rhythm is used to control the attribute value of the particle transparency of the particle primitive model at the initial moment of transparency change. If the random values of flickering rhythm corresponding to the particle primitive models are different, the attribute values of the particle transparency of the particle primitive models at the initial moment of transparency change are also different, thus visually presenting the effect that the particle primitive models have different flickering rhythms. For example, some particle primitive models flicker from a completely transparent state, and some particle primitive models flicker from a completely opaque state.

Taking FIG. 2B as an example to explain. FIG. 2B is a schematic diagram of a change curve of an attribute value of particle transparency provided by an embodiment of the present disclosure. As shown in FIG. 2B, the coordinate value on the abscissa represents the ratio of the existing time period of a particle to the lifecycle of the particle, and the coordinate value on the ordinate represents the attribute value of the particle transparency of the particle.

The change curve shown in FIG. 2B is the change of the attribute value of the particle transparency based on formula (1) when the flickering frequency in formula (1) is 10 and the random value of flickering rhythm is 0. As shown in FIG. 2B, the attribute value of the particle transparency changes periodically between 0 and 1, that is, the transparency of the particle primitive model changes periodically between completely transparent and completely opaque, which produces a flickering effect that flickers on and off on the vision.

In other embodiments, the transparency change means that during the lifecycle of the particle primitive model, the transparency of the particle primitive model changes periodically from the m-th second in the lifecycle of the particle primitive model, and m is a positive number.

For example, the particle transparency of the i-th particle among the plurality of particles is expressed as formula (2):

$${C}_{i} ( t ) = max ( {B}_{i} ( t ) , D ( t ) ) \qquad formula ( 2 )$$

where Cᵢ(t) represents the particle transparency of the i-th particle at time t, t represents the time period when the i-th particle has existed, Bᵢ(t) represents a first factor corresponding to the i-th particle, D(t) represents a second factor corresponding to the i-th particle, and max(*) represents finding the maximum value. For example, the first factor is used to control the periodic change of the transparency of the particle primitive model, and the second factor is used to control the start time of the periodic change of the transparency of the particle primitive model, that is, to control the specific value of m.

In some embodiments, the first factor may be obtained by formula (1), which is not repeated here.

FIG. 2C is a schematic diagram of a change curve of a second factor provided by an embodiment of the present disclosure. As shown in FIG. 2C, the coordinate value on the abscissa represents the ratio of the existing time period of a particle to the lifecycle of the particle, and the coordinate value on the ordinate represents the attribute value of the particle transparency of the particle.

As shown in FIG. 2C, the change of the transparency of the particle primitive model controlled by the second factor D(t) includes three stages: first, when a particle is born, that is, at the 0th second in the lifecycle of the particle, the attribute value of the particle transparency is 1, and at this time, the particle primitive model corresponding to the particle is in a completely opaque state: then, in a first stage from the 0th second to the (0.2*t)^{th} second, the attribute value of the particle transparency decreases, and at the (0.2*t)^{th} second in the lifecycle of the particle, the attribute value of the particle transparency becomes 0.8, at this time, the particle primitive model corresponding to the particle is in a state of certain transparency: then, in a second stage from (0.2*t)^{th} second to (0.3*t)^{th} second, the attribute value of the particle transparency decreases rapidly, at the (0.3*t)^{th} second in the lifecycle of the particle, the attribute value of the particle transparency becomes 0.1, and at this time, the particle primitive model corresponding to the particle is in a state of another transparency (the certain transparency is higher than another transparency); finally, in a third stage from (0.3*t)^{th} second to t^{th} second, the attribute value of the particle transparency gradually decreases from 0.1 to 0. Finally, at the end of the lifecycle of the particle primitive model, the particle primitive model corresponding to the particle is in a completely transparent state.

FIG. 2D is a schematic diagram of a change curve of an attribute value of particle transparency provided by an embodiment of the present disclosure. As shown in FIG. 2D, the coordinate value on the abscissa represents the ratio of the existing time period of a particle to the lifecycle of the particle, and the coordinate value on the ordinate represents the attribute value of the particle transparency of the particle.

For example, the attribute value of the particle transparency may be determined by formula (2), the first factor may be determined by formula (1), and the second factor may be determined based on the change curve shown in FIG. 2C.

As shown in FIG. 2D, through the joint action of the first factor and the second factor, from the birth time of the particle to the (0.2*t)^{th} second in the lifecycle of the particle, because the attribute value of the particle transparency is the maximum value of the first factor and the second factor at a certain moment, the attribute value of the particle transparency is relatively high as a whole, so that the attribute value of the particle transparency is in a relatively high state, and the flickering effect of the particle primitive model is not significant at this time. From the (0.2*t)^{th} second, the particle transparency of the particle begins to switch widely between 0 and 1, thus visually making the particle primitive model corresponding to the particle produce a flickering effect. It can be seen that the start time of the flickering effect produced by the first factor can be controlled by the second factor.

In other embodiments, the aforementioned transparency changes may be combined to obtain a richer visual effect. For example, the transparency change includes changing a transparency of the particle primitive model within a first m seconds of the lifecycle of the particle primitive model, and periodically changing, starting from the m-th second in the lifecycle of the particle primitive model, the transparency of the particle primitive model accompanied by gradually decreasing transparency peak of the transparency of the particle primitive model, where m is a positive number.

In one embodiment, the particle transparency of the i-th particle among the plurality of particles is expressed as formula (3):

$${E}_{i} ( t ) = max ( {B}_{i} ( t ) , D ( t ) ) * {A}_{i} ( t ) \qquad formula ( 3 )$$

where t represents the time period when the i-th particle has existed, Eᵢ(t) represents the particle transparency of the i-th particle at time t, Bᵢ(t) represents the first factor corresponding to the i-th particle, D(t) represents the second factor corresponding to the i-th particle, and max(*) represents finding the maximum value, Aᵢ(t) represents a third factor corresponding to the i-th particle. Here, the first factor is used to control the periodic change of the transparency of the particle primitive model, and the second factor is used to control the start time of the periodic change of the transparency of the particle primitive model, and the third factor is used to control the peak transparency of the particle primitive model at each moment to change from the first transparency to the second transparency and then to the third transparency, both the first transparency and the third transparency are different from the second transparency.

In some embodiments, the first factor in formula (3) may be determined by formula (1), and the second factor in formula (3) may have the same effect as the second factor in formula (2). For example, the second factor may be determined by a curve as shown in FIG. 2C, which is used to control the start time of the flickering effect generated by the first factor.

FIG. 2E is a schematic diagram of a change curve of another second factor provided by an embodiment of the present disclosure. As shown in FIG. 2E, the coordinate value on the abscissa represents the ratio of the existing time period of a particle to the lifecycle of the particle, and the coordinate value on the ordinate represents the attribute value of the particle transparency of the particle.

As shown in FIG. 2E, the change of the transparency of the particle primitive model controlled by the second factor also includes three stages. First, in a first stage from the 0th second to the (0.25*t)^{th} second, the attribute value of the particle transparency decreases, and at the (0.25*t)^{th} second in the lifecycle of the particle, the attribute value of the particle transparency becomes 0.8. Then, in a second stage from (0.25*t)^{th} second to (0.4*t)^{th} second, the attribute value of the particle transparency decreases rapidly, and at the (0.4*t)^{th} second in the lifecycle of the particle, the attribute value of the particle transparency becomes 0.17. Finally, in a third stage from (0.4*t)^{th} second to t^{th} second, the attribute value of the particle transparency gradually decreases from 0.17 to 0. Finally, at the end of the lifecycle of the particle primitive model, the particle primitive model corresponding to the particle is in a completely transparent state.

When the third factor is the change curve as shown in FIG. 2A, the second factor is the change curve as shown in FIG. 2E, and the first factor is determined by formula (1) (for example, the change curve as shown in FIG. 2B), in the first m seconds (for example, m=0.25*t) in the lifecycle of the particle primitive model, the value of the second factor is greater than that of the first factor in most cases, and the transparency of the particle primitive model is mainly determined by the third factor and the second factor, and at this time, there is no flickering effect but the transparency is constantly changing. Thereafter, starting from the m^{th} second of the lifecycle of the particle primitive model, because the value of the first factor is greater than the value of the second factor in most cases, the transparency of the particle primitive model is mainly determined by the first factor and the third factor. At this time, the transparency change is the effect of combining the flickering effect with the peak change of the transparency of the particle primitive model corresponding to the third factor. For example, in some embodiments, from the m^{th} second to the end of the lifecycle, the value of the third factor decreases continuously. The transparency of the i-th particle primitive model continues to decrease, and superimposing the effect of the first factor, the transparency of the i-th particle primitive model also has the effect of flickering in the process of continuously decreasing transparency, thus presenting a visual effect that gradually disappears and flickers.

It should be noted that the change curve of the first factor is not limited to the curve shown in FIG. 2B, and the change curve of the second factor is not limited to the curve line chart with curvature shown in FIG. 2E, but may also be a straight line chart shown in FIG. 2C, which is not limited by the present disclosure.

In one embodiment, the visual effect includes the size change of the particle primitive model, for example, the size change is controlled by the attribute value of the particle size of the particle corresponding to the particle primitive model.

For example, the size change means that the size of the particle primitive model changes from the first size to the second size and then to the third size in the lifecycle of the particle primitive model, and the second size is not equal to both the first size and the third size.

For example, the first size and the third size are smaller than the second size, that is, in the lifecycle of the particle primitive model, the size of the particle primitive model may change from small to large and then to small, so as to show the visual effect that the particle primitive model gradually appears and disappears.

In one embodiment, the visual effect includes the rotation change of the particle primitive model, for example, the rotation change is controlled by the attribute value of the particle rotation speed of the particle corresponding to the particle primitive model. For example, the rotation change means that the particle primitive model rotates at a preset rotation speed during the lifecycle of the particle primitive model. The preset rotation speed is the attribute value of the particle rotation speed of the particle.

The preset rotation speed is a random value within the preset range, and the preset rotation speed remains unchanged during the lifecycle of the particle primitive model. For example, when initializing the attribute values of the particle attributes, the initial attribute values of different particle rotation speeds are set for particles to present a visual effect that different particle primitive models have different rotation speeds.

In one embodiment, the visual effect includes the color change of the particle primitive model, for example, the color change is controlled by the attribute value of the particle color of the particle corresponding to the particle primitive model. For example, the color change means that the color of the particle primitive model changes during the lifecycle of the particle primitive model. For example, the color of the particle primitive model may change from yellow to pink and then to red during the lifecycle of the particle primitive model, for example, RGB values may be used for specific settings.

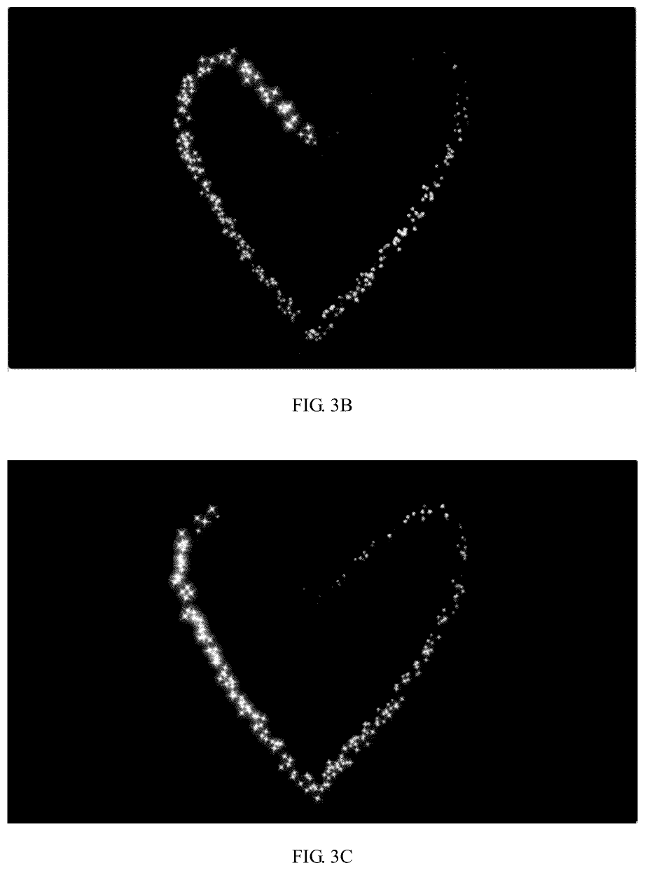

At least one embodiment of the present disclosure also provides a method for generating a video. FIG. 3A is a schematic flowchart of a method for generating a video provided by at least one embodiment of the present disclosure. For example, as shown in FIG. 3A, the method for generating the video includes steps S210-S230.

In step S210, determining a visual effect trajectory in a video to be processed.

In step S220, generating a trailing visual effect at the visual effect trajectory.

In step S230, superimposing the trailing visual effect in the video to be processed to generate the video.

For example, in step S220, the trailing visual effect may be generated according to the method for generating the trailing visual effect based on the particle flow described in any embodiment of the present disclosure.

In the method for generating the video provided by the embodiment of the present disclosure, the generated trailing visual effect may be superimposed onto the video to be processed, for example, at the visual effect trajectory in the video to be processed, so that the trailing visual effect may be implemented on different videos to be processed, and the application requirements of various scenes can be met. For example, when combined with AR technology, the method can achieve the trailing visual effect as the target object such as a fingertip moves.

For example, the video to be processed may be a video that is shot in real-time or a video that is pre-shot and stored. For example, when the method of generating the video is applied to an electronic device, the video to be processed may be a video stored in the electronic device or a video shot by a user in real time: in this case, if the trailing visual effect is implemented by the electronic device itself, the electronic device may process the video to be processed in real time: if the trailing visual effect is implemented by the server, the video stored in the electronic device or the video shot in real time is uploaded to the server through the network, and the server performs the trailing effect on the video before returning it to the electronic device. In addition, the user may also upload the generated video from the electronic device to the server through the network, and send the generated video to other users through social applications or release the generated video to the public.

According to the different structures of different electronic devices, the user may trigger video shooting events through a physical button, a displayed touch button, voice control, and other methods.

For example, the user may click the video shooting button on the touch display screen to start shooting the video to be processed in real time.

For example, video shooting events may be controlled by the user through voice, and the present disclosure does not limit the trigger conditions for shooting.

For example, in some embodiments, step S210 may include: in response to detecting a target object in the video to be processed, identifying a feature point on the target object as a target point, and determining the visual effect trajectory according to a movement trajectory of the target point.

For example, the target object includes a hand, and the target point includes a fingertip of the hand, for example, the fingertip may be the fingertip of the index finger, and the method for generating the video further includes: displaying the trailing visual effect at the movement trajectory of the fingertip. Therefore, visually, it can be achieved that the trailing visual effect may move with the movement of the fingertip, that is, the trailing visual effect may be generated with the movement of the fingertip. For example, the fingertip may be the fingertip of the index finger, etc.

For example, in some embodiments, the visual effect trajectory may be a preset trajectory, for example, a heart-shaped trajectory, a trajectory that forms specific characters, numbers, specific graphics, etc.

In some embodiments, step S220 may include: mapping the trailing visual effect onto the visual effect trajectory so that the trailing visual effect is superimposed on the visual effect trajectory: In one embodiment, the electronic device may superimpose and display the trailing visual effect on the visual effect trajectory based on the AR technology.

For example, in some embodiments, when the visual effect trajectory is determined according to the movement of the user's fingertip, the user may click the video shooting button in the touch display screen of the electronic device, thereby starting to shoot the video, or the user also may control the video shooting through voice control. When the captured video includes the user's fingertip, a trailing visual effect may be formed on the display screen with the moving of the fingertip. For example, when the user's fingertip moves out of the display screen, the trailing visual effect gradually disappears from the starting position of the trailing visual effect. Therefore, the user's experience in shooting videos or watching videos can be increased.

For example, in other embodiments, when the visual effect trajectory is a preset trajectory, the trailing visual effect may automatically change continuously along the preset trajectory at a certain rate. For example, the trailing visual effect may be triggered based on the detection of a specific object in the video to be processed. For example, if the specific object is the fingertip of the index finger, the visual effect trajectory may be a heart-shaped trajectory around the fingertip of the user's index finger. For example, when the video to be processed comprises the fingertip of the user's index finger, the trailing visual effect may be formed around the fingertip of the user's index finger, the trailing visual effect may continuously move along the heart-shaped trajectory at a certain rate. When the fingertip of the user's index finger is not detected in the video to be processed, the trailing visual effect disappears.

For example, in some embodiments, step S230 may include: superimposing and rendering the trailing visual effect and the video to be processed to generate a video superimposed with the trailing visual effect.

For example, FIG. 3B and FIG. 3C are schematic diagrams of a trailing visual effect provided by at least one embodiment of the present disclosure. For example, according to the method for generating the video provided by at least one embodiment of the present disclosure, the video superimposed with a trailing visual effect is generated, for example, FIG. 3B is a schematic diagram of the trailing visual effect in the video at a first time, and FIG. 3C is a schematic diagram of the trailing visual effect in the video at a second time.

For example, the visual effect trajectory is a preset heart-shaped trajectory (or a heart-shaped trajectory drawn by the user in the video to be processed), and the trailing visual effect can automatically continuously change along the heart-shaped trajectory at a certain rate, thus presenting a visual effect that continuously produces trailing visual effects as moving along the heart-shaped trajectory.

For example, the trailing visual effect is composed of a plurality of particle primitive models, each of the particle primitive models presents the shape of a four-corner star, and each particle primitive model has different visual effects.

For example, the visual effect may include size change. As can be seen from FIG. 3B and FIG. 3C, the size of the particle primitive model is different at different times, so as to show the visual effect that the particle primitive model gradually appears and gradually disappears.

For example, the visual effect may include transparency change. As can be seen from FIG. 3B and FIG. 3C, the transparency of the particle primitive model is different at different times. For example, the particle primitive model may be made to have any of the aforementioned transparency changes to produce the visual effects such as flickering, fading in and out, and fading out and in, etc.

For example, the visual effect may include rotation change. As can be seen from FIG. 3B and FIG. 3C, the particle primitive model has different rotation states at different times, thus producing rich visual effects.

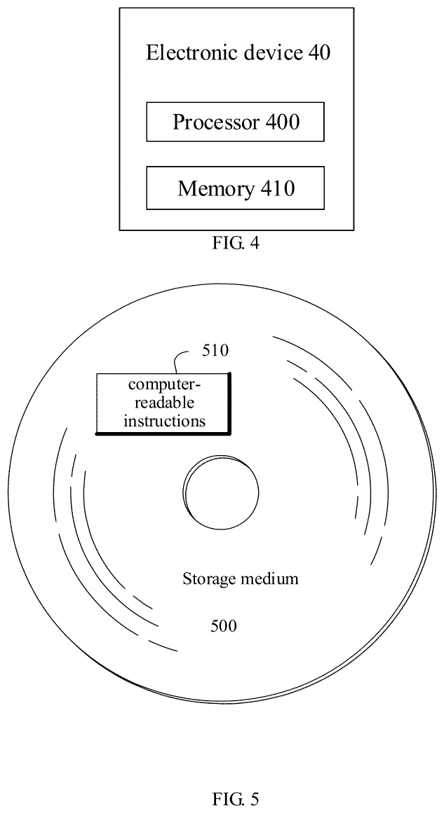

Some embodiments of that present disclosure also provide an electronic device. FIG. 4 is a schematic block diagram of an electronic device provided by at least one embodiment of the present disclosure.

For example, as shown in FIG. 4, the electronic device 40 includes a processor 400 and a memory 410. It should be noted that the components of the electronic device 40 shown in FIG. 4 are only exemplary, not restrictive, and the electronic device 40 may also have other components according to actual application requirements.

For example, the processor 400 and the memory 410 may communicate with each other directly or indirectly.

For example, the processor 400 and the memory 410 may communicate through a network. The network may include a wireless network, a wired network, and/or any combination of wireless and wired networks. The processor 400 and the memory 410 may also communicate with each other through the system bus, which is not limited by the present disclosure.

For example, in some embodiments, the memory 410 is used to non-transitorily store computer-readable instructions. The processor 400 is used to execute the computer-readable instructions, the computer-readable instructions, when run by the processor 400, achieve the method for generating the trailing visual effect based on the particle flow according to any of the above embodiments. For the specific implementation of each step of the method for generating the trailing visual effect based on the particle flow and related explanations, please refer to the above-mentioned embodiments of the method for generating the trailing visual effect based on the particle flow; and the repetition will not be repeated here.

For example, in other embodiments, the computer-readable instructions, when executed by the processor 400, may also achieve the method for generating the video according to any of the above embodiments. For the specific implementation of each step of the method for generating the video and related explanations, please refer to the embodiment of the above method for generating the video, and the repetition will not be repeated here.

For example, the processor 400 and the memory 410 may be set on the server side (or in the cloud).

For example, the processor 400 may control other components in the electronic device 40 to perform desired functions. The processor 400 may be a central processing unit (CPU), a graphics processing unit (GPU), a network processor (NP), etc., and can also be a digital signal processor (DSP), an application specific integrated circuit (ASIC), a field programmable gate array (FPGA) or other programmable logic devices, discrete gate or transistor logic devices, and discrete hardware components. The central processing unit (CPU) may be X86 or ARM architecture or the like.

For example, the memory 410 may include any combination of one or more computer program products, and the computer program products may include various forms of computer-readable storage media, such as volatile memory and/or non-volatile memory. The volatile memory may include, for example, random access memory (RAM) and/or cache, etc. The non-volatile memory may include, for example, read-only memory (ROM), hard disk, erasable programmable read-only memory (EPROM), portable compact disk read-only memory (CD-ROM), USB memory, flash memory, etc. One or more computer-readable instructions may be stored on the computer-readable storage medium, and the processor 400 may execute the computer-readable instructions to implement various functions of the electronic device 40. Various applications and data may also be stored in the storage medium.

For example, in some embodiments, the electronic device 40 may be a mobile phone, a tablet computer, an electronic paper, a television, a display, a notebook computer, a digital photo frame, a navigator, a wearable electronic device, a smart home device, and the like.

For example, the electronic device 40 may include a display panel, and the display panel may be used to display a trailing visual effect, a video superimposed with the trailing visual effect, and the like. For example, the display panel may be a rectangular panel, a circular panel, an oval panel, a polygonal panel, or the like. In addition, the display panel may be not only a flat panel, but also a curved panel or even a spherical panel.

For example, the electronic device 40 can have a touch function, that is, the electronic device 40 may be a touch device.

For example, for a detailed description of the process in which the electronic device 40 executes the method for generating the trailing visual effect based on the particle flow and the method for generating the video, reference can be made to the relevant descriptions in the embodiments of the method for generating the trailing visual effect based on the particle flow and the method for generating the video, and the repetition will not be repeated here.

FIG. 5 is a schematic diagram of a non-transitory computer-readable storage medium provided by at least one embodiment of the present disclosure. For example, as shown in FIG. 5, one or more computer-readable instructions 510 may be stored non-transitorily on a storage medium 500. For example, when the computer-readable instructions 510 are executed by a processor, one or more steps in the method for generating the trailing visual effect based on the particle flow described above may be performed. For another example, when the computer-readable instructions 510 are executed by a processor, one or more steps in the method for generating the video described above may also be performed.

For example, the storage medium 500 may be applied to the electronic device 40. For example, the storage medium 500 may include the memory 410 in the electronic device 40.

For example, for the description of the storage medium 500, reference may be made to the description of the memory 410 in the embodiment of the electronic device 40, and the repetition is not repeated here.

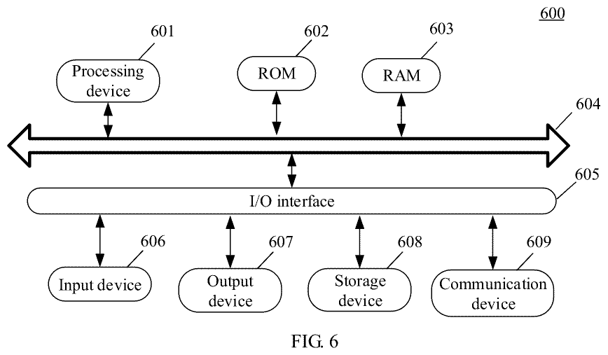

Referring now to FIG. 6, FIG. 6 shows a structural schematic diagram of an electronic device (for example, the electronic device may include the display device described in the above embodiment) 600 suitable for implementing the embodiment of the present disclosure. The electronic device in the embodiment of the present disclosure may include, but are not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device, and the like, and fixed terminals such as a digital TV, a desktop computer, a smart home device, and the like. The electronic device shown in FIG. 6 is merely an example, and should not impose any limitation on the functions and the range of use of the embodiments of the present disclosure.

As shown in FIG. 6, the electronic device 600 may include a processing device (such as a central processing unit, a graphics processing unit, etc.) 601, which can perform various suitable actions and processing according to a program stored in a read-only memory (ROM) 602 or a program loaded from a storage device 608 into a random access memory (RAM) 603. The RAM 603 further stores various programs and data required for operations of the electronic device 600. The processing device 601, the ROM 602, and the RAM 603 are connected to each other through a bus 604. An input/output (I/O) interface 605 is also connected to the bus 604.

Usually, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a loudspeaker, a vibrator, etc.; a storage device 608 including, for example, a magnetic tape, a hard disk, etc.; and a communication device 609. The communication unit 609 may allow the electronic device 600 to communicate wirelessly or by wire with other devices to exchange data. Although FIG. 6 illustrates the electronic device 600 having various devices, it is to be understood that all the illustrated devices are not necessarily implemented or included. More or less devices may be implemented or included alternatively:

Particularly, according to the embodiments of the present disclosure, the process described above with reference to the flowchart may be implemented as a computer software program. For example, an embodiment of the present disclosure includes a computer program product, which includes a computer program carried on a non-transitory computer-readable medium. The computer program includes program codes for executing the method shown in the flowchart. In such an embodiment, the computer program may be downloaded online through the communication device 609 and installed, or installed from the storage device 608, or installed from the ROM 602. When the computer program is executed by the processing device 601, the above-mentioned functions defined in the method provided in the embodiments of the present disclosure are executed.

It should be noted that in the context of the present disclosure, the computer-readable medium may be a tangible medium, which may comprise or store programs for use by or in combination with an instruction execution system, apparatus, or device. The computer-readable medium may be a computer-readable signal medium or a computer-readable storage medium or any combination thereof. For example, the computer-readable storage medium may be, but not limited to, an electric, magnetic, optical, electromagnetic, infrared, or semiconductor system, apparatus, or device, or any combination of them. More specific examples of the computer-readable storage medium may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a variety of forms, including but not limited to an electromagnetic signal, an optical signal, or any appropriate combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF), and the like, or any appropriate combination of them.

In some implementations, the client and the server may communicate with any network protocol currently known or to be researched and developed in the future such as HyperText Transfer Protocol (HTTP), and may communicate (e.g., via a communication network) and interconnect with digital data in any form or medium. Examples of communication networks include a Local Area Network (“LAN”), a Wide Area Network (“WAN”), the Internet, and an end-to-end network (e.g., an ad hoc end-to-end network), as well as any network currently known or to be researched and developed in the future.

The above-described computer-readable medium may be included in the above-described electronic device: or may also exist alone without being assembled into the electronic device.

Computer program codes for performing the operations in the present disclosure may be written in one or more programming languages or a combination thereof. The programming languages include object oriented programming languages, such as Java, Smalltalk, and C++, and also include conventional procedural programming languages, such as “C” language or similar programming languages. The program code can be executed fully on a user's computer, executed partially on a user's computer, executed as an independent software package, executed partially on a user's computer and partially on a remote computer, or executed fully on a remote computer or a server. In the scenario involving a remote computer, the remote computer may be connected to the user's computer through any type of networks including a local area network (LAN) or a wide area network (WAN), or may be connected to an external computer (e.g., connected through the Internet from an Internet Service Provider).

The flowcharts and block diagrams in the accompanying drawings illustrate system architectures, functions, and operations that may be implemented by the system, method, and computer program products according to the various embodiments of the present disclosure. In this regard, each block in the flowcharts or block diagrams may represent a module, a program segment, or a part of code, and the module, the program segment, or the part of code includes one or more executable instructions for implementing specified logic functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of a dedicated hardware and computer instructions.

Related units described in the embodiments of the present disclosure may be implemented by software, or may be implemented by hardware. The name of a unit does not constitute a limitation on the unit itself.

The functions described above in the present disclosure may be executed at least in part by one or more hardware logic components. For example, without limitations, exemplary types of the hardware logic components that can be used include: a field programmable gate array (FPGA), an application specific integrated circuit (ASIC), an application specific standard product (ASSP), a system on chip (SOC), a complex programmable logic device (CPLD), and the like.

According to one or more embodiments of the present disclosure, a method for generating a trailing visual effect based on a particle flow comprises: acquiring an extending trajectory of the particle flow: generating, in a three-dimension space for generating the trailing visual effect, a plurality of particles for forming the particle flow according to the extending trajectory: rendering the plurality of particles to obtain a plurality of particle primitive models; and generating the trailing visual effect based on the plurality of particle primitive models.

According to one or more embodiments of the present disclosure, generating the plurality of particles for forming the particle flow according to the extending trajectory, comprises: generating the plurality of particles at equal intervals or random intervals along the extending trajectory: or generating the plurality of particles at equal time intervals or random time intervals along the extending trajectory.

According to one or more embodiments of the present disclosure, obtaining the extending trajectory of the particle flow; comprises: acquiring a video to be processed; detecting a target object in the video to be processed: determining a movement trajectory of the target object in the video to be processed; and converting the movement trajectory into the extending trajectory of the particle flow; where the extending trajectory is a trajectory that is obtained by mapping the movement trajectory into the three-dimension space.

According to one or more embodiments of the present disclosure, generating the plurality of particles at equal intervals along the extending trajectory, comprises: every time the target object moves a predetermined distance along the extending trajectory, randomly generating at least one particle in a three-dimension region including a position where the target object is located to form the particle flow:

According to one or more embodiments of the present disclosure, the extending trajectory is a preset trajectory, generating the plurality of particles at equal intervals along the extending trajectory, comprises: along the extending trajectory, sequentially randomly generating at least one particle in each of three-dimension regions respectively including positions at every predetermined distance on the extending trajectory to form the particle flow:

According to one or more embodiments of the present disclosure, each particle in the plurality of particles has at least one visual attribute, and the at least one visual attribute at least comprises one or more selected from a group consisting of particle size, particle color, particle transparency, and particle rotation speed, and the at least one visual attribute is used for controlling a visual effect of a particle primitive model corresponding to the each particle.

According to one or more embodiments of the present disclosure, each particle further has a lifecycle attribute, the lifecycle attribute is used to represent a lifecycle of the particle primitive model corresponding to the each particle, at least part particle primitive models of the plurality of particle primitive models display at least a preset time period, and lifecycles of the at least part particle primitive models are greater than or equal to the preset time period.

According to one or more embodiments of the present disclosure, the visual effect of the particle primitive model comprises a transparency change of the particle primitive model.

According to one or more embodiments of the present disclosure, the transparency change comprises changing a transparency of the particle primitive model from a first transparency to a second transparency and then to a third transparency during the lifecycle of the particle primitive model, where both the first transparency and the third transparency are different from the second transparency.

According to one or more embodiments of the present disclosure, the transparency change comprises periodically changing a transparency of the particle primitive model within the lifecycle of the particle primitive model.

According to one or more embodiments of the present disclosure, the transparency change comprises, during the lifecycle of the particle primitive model, periodically changing a transparency of the particle primitive model from an m-th second in the lifecycle of the particle primitive model, where m is a positive number.

According to one or more embodiments of the present disclosure, the transparency change comprises changing a transparency of the particle primitive model within a first m seconds of the lifecycle of the particle primitive model, and periodically changing, starting from the m-th second in the lifecycle of the particle primitive model, the transparency of the particle primitive model accompanied by gradually decreasing transparency peak of the transparency of the particle primitive model, where m is a positive number.

According to one or more embodiments of the present disclosure, the visual effect of the particle primitive model comprises a size change of the particle primitive model.

According to one or more embodiments of the present disclosure, the size change indicates that a size of the particle primitive model changes from a first size to a second size and then to a third size within the lifecycle of the particle primitive model, and both the first size and the third size are smaller than the second size.

According to one or more embodiments of the present disclosure, the visual effect of the particle primitive model comprises a rotation change of the particle primitive model, the rotation change indicates that the particle primitive model rotates at a preset rotation speed within the lifecycle of the particle primitive model.

According to one or more embodiments of the present disclosure, the preset rotation speed is a random value within a preset range, and the preset rotation speed remains unchanged during the lifecycle of the particle primitive model.

According to one or more embodiments of the present disclosure, further comprising: after displaying the at least part particle primitive models for the preset time period, successively adjusting transparencies of the at least part particle primitive models to be completely transparent according to an order of generating the plurality of particles.

According to one or more embodiments of the present disclosure, a method for generating a video, comprising: determining a visual effect trajectory in a video to be processed; generating a trailing visual effect at the visual effect trajectory, where the trailing visual effect is generated according to the method for generating a trailing visual effect based on a particle flow described in any embodiment of the present disclosure; and superimposing the trailing visual effect in the video to be processed to generate the video.

According to one or more embodiments of the present disclosure, generating the trailing visual effect at the visual effect trajectory, comprises: mapping the trailing visual effect onto the visual effect trajectory so that the trailing visual effect is superimposed on the visual effect trajectory.

According to one or more embodiments of the present disclosure, determining the visual effect trajectory in the video to be processed, comprises: in response to detecting a target object in the video to be processed, identifying a feature point on the target object as a target point, and determining the visual effect trajectory according to a movement trajectory of the target point.

According to one or more embodiments of the present disclosure, the visual effect trajectory is a preset visual effect trajectory.

According to one or more embodiments of the present disclosure, the target object comprises a hand, and the target point comprises a fingertip of the hand, the method further comprises: displaying the trailing visual effect at a movement trajectory of the fingertip.

According to one or more embodiments of the present disclosure, an electronic device comprises: a memory, for non-transitorily storing computer-readable instructions: a processor, configured to execute the computer-executable instructions, and the computer-executable instructions, when executed by the processor, implement the method for generating the trailing visual effect based on the particle flow according to any embodiment of the present disclosure.

According to one or more embodiments of the present disclosure, a non-transitory computer-readable storage medium is provided, the non-transitory computer-readable storage medium stores computer-executable instructions, and the computer-executable instructions, when executed by a processor, implement the method for generating the trailing visual effect according to any embodiment of the present disclosure.

The foregoing descriptions are merely the illustrations of the preferred embodiments of the present disclosure and the explanations of the technical principles involved. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated particular order or in a sequential order. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Conversely, various features described in the context of a single embodiment may also be implemented in various embodiments individually or in a plurality of embodiments in any appropriate sub-combination.

Although the present subject matter has been described in a language specific to structural features and/or logical method acts, it will be appreciated that the subject matter defined in the appended claims is not necessarily limited to the particular features or acts described above. Rather, the particular features and acts described above are merely exemplary forms for implementing the claims.

For the present disclosure, the following statements should be noted:
(1) The accompanying drawings of the embodiment(s) of the present disclosure involve only the structure(s) in connection with the embodiment(s) of the present disclosure, and other structure(s) can refer to common design(s).
(2) In case of no conflict, the embodiments of the present disclosure and the features in the embodiment(s) can be combined with each other to obtain new embodiment(s).

What have been described above are only specific implementations of the present disclosure, the protection scope of the present disclosure is not limited thereto, and the protection scope of the present disclosure should be based on the protection scope of the claims.

1. A method for generating a trailing visual effect based on a particle flow, comprising:
acquiring an extending trajectory of the particle flow;
generating, in a three-dimension space for generating the trailing visual effect, a plurality of particles for forming the particle flow according to the extending trajectory;
rendering the plurality of particles to obtain a plurality of particle primitive models; and
generating the trailing visual effect based on the plurality of particle primitive models.

2. The method according to claim 1, wherein generating the plurality of particles for forming the particle flow according to the extending trajectory, comprises:
generating the plurality of particles at equal intervals or random intervals along the extending trajectory; or
generating the plurality of particles at equal time intervals or random time intervals along the extending trajectory.

3. The method according to claim 2, wherein obtaining the extending trajectory of the particle flow, comprises:
acquiring a video to be processed;
detecting a target object in the video to be processed;
determining a movement trajectory of the target object in the video to be processed; and
converting the movement trajectory into the extending trajectory of the particle flow, wherein the extending trajectory is a trajectory that is obtained by mapping the movement trajectory into the three-dimension space.

4. The method according to claim 3, wherein generating the plurality of particles at equal intervals along the extending trajectory, comprises:
every time the target object moves a predetermined distance along the extending trajectory, randomly generating at least one particle in a three-dimension region including a position where the target object is located to form the particle flow.

5. The method according to claim 2, wherein the extending trajectory is a preset trajectory,
generating the plurality of particles at equal intervals along the extending trajectory, comprises:
along the extending trajectory, sequentially randomly generating at least one particle in each of three-dimension regions respectively including positions at every predetermined distance on the extending trajectory to form the particle flow.

6. The method according to claim 1, wherein each particle in the plurality of particles has at least one visual attribute, and the at least one visual attribute at least comprises one or more selected from a group consisting of particle size, particle color, particle transparency, and particle rotation speed, and the at least one visual attribute is used for controlling a visual effect of a particle primitive model corresponding to the each particle;
wherein the each particle further has a lifecycle attribute, the lifecycle attribute is used to represent a lifecycle of the particle primitive model corresponding to the each particle,
at least part particle primitive models of the plurality of particle primitive models display at least a preset time period, and
lifecycles of the at least part particle primitive models are greater than or equal to the preset time period.

7. (canceled)

8. The method according to claim 6, wherein the visual effect of the particle primitive model comprises a transparency change of the particle primitive model.

9. The method according to claim 8, wherein the transparency change comprises changing a transparency of the particle primitive model from a first transparency to a second transparency and then to a third transparency during the lifecycle of the particle primitive model, wherein both the first transparency and the third transparency are different from the second transparency.

10. The method according to claim 8, wherein the transparency change comprises periodically changing a transparency of the particle primitive model within the lifecycle of the particle primitive model.

11. The method according to claim 8, wherein the transparency change comprises, during the lifecycle of the particle primitive model, periodically changing a transparency of the particle primitive model from an m-th second in the lifecycle of the particle primitive model, where m is a positive number.

12. The method according to claim 8, wherein the transparency change comprises changing a transparency of the particle primitive model within a first m seconds of the lifecycle of the particle primitive model, and periodically changing, starting from the m-th second in the lifecycle of the particle primitive model, the transparency of the particle primitive model accompanied by gradually decreasing transparency peak of the transparency of the particle primitive model, where m is a positive number.

13. The method according to claim 6, wherein the visual effect of the particle primitive model comprises a size change of the particle primitive model; and
wherein the size change indicates that a size of the particle primitive model changes from a first size to a second size and then to a third size within the lifecycle of the particle primitive model, wherein both the first size and the third size are smaller than the second size.

14. (canceled)

15. The method according to claim 6, wherein the visual effect of the particle primitive model comprises a rotation change of the particle primitive model, the rotation change indicates that the particle primitive model rotates at a preset rotation speed within the lifecycle of the particle primitive model; and
wherein the preset rotation speed is a random value within a preset range, and the preset rotation speed remains unchanged during the lifecycle of the particle primitive model.

16. (canceled)

17. The method according to claim 6, further comprising:
after displaying the at least part particle primitive models for the preset time period, successively adjusting transparencies of the at least part particle primitive models to be completely transparent according to an order of generating the plurality of particles.

18. A method for generating a video, comprising:
determining a visual effect trajectory in a video to be processed;
generating a trailing visual effect at the visual effect trajectory; and
superimposing the trailing visual effect in the video to be processed to generate the video;
wherein the trailing visual effect is generated according to a method for generating a trailing visual effect based on a particle flow, and the method comprises:
acquiring an extending trajectory of the particle flow;
generating, in a three-dimension space for generating the trailing visual effect, a plurality of particles for forming the particle flow according to the extending trajectory;
rendering the plurality of particles to obtain a plurality of particle primitive models; and
generating the trailing visual effect based on the plurality of particle primitive models.

19. The method according to claim 18, wherein generating the trailing visual effect at the visual effect trajectory, comprises:
mapping the trailing visual effect onto the visual effect trajectory so that the trailing visual effect is superimposed on the visual effect trajectory.

20. The method according to claim 18, wherein the visual effect trajectory is a preset visual effect trajectory, or
determining the visual effect trajectory in the video to be processed, comprises:
in response to detecting a target object in the video to be processed, identifying a feature point on the target object as a target point, and determining the visual effect trajectory according to a movement trajectory of the target point.

21. (canceled)

22. The method according to claim 18, wherein the target object comprises a hand, and the target point comprises a fingertip of the hand,
the method further comprises:
displaying the trailing visual effect at a movement trajectory of the fingertip.

23. An electronic device, comprising:
a memory, for non-transitorily storing computer-readable instructions;
a processor, configured to execute the computer-readable instructions,
wherein the computer-readable instructions, when executed by the processor, implement a method for generating a trailing visual effect based on a particle flow, and the method comprises:
acquiring an extending trajectory of the particle flow;
generating, in a three-dimension space for generating the trailing visual effect, a plurality of particles for forming the particle flow according to the extending trajectory;
rendering the plurality of particles to obtain a plurality of particle primitive models; and
generating the trailing visual effect based on the plurality of particle primitive models.

24. A non-transitory computer-readable storage medium, wherein the non-transitory computer-readable storage medium stores computer-readable instructions, and the computer-readable instructions, when executed by a processor, implement the method for generating the trailing visual effect based on the particle flow according to claim 1.
